(19) United States
(12) Patent Application Publication
(10) Pub. No.: US 2022/0237755 A1
(43) Pub. Date: Jul. 28, 2022

(54) IMAGE ENHANCEMENT METHOD AND IMAGE PROCESSING DEVICE

(71) Applicant: NOVATEK Microelectronics Corp., Hsinchu (TW)

(72) Inventor: Xiao-Jing YANG, Xi'an City (CN)

(21) Appl. No.: 17/161,621

(22) Filed: Jan. 28, 2021

(51) Int. Cl. G06T 5/40; G06T 5/00

(52) U.S. Cl. CPC G06T 5/40; G06T 2207/20076; G06T 5/007

(57) ABSTRACT

An image enhancement, for enhancing an input image, includes following steps. A distribution histogram corresponding to the input image is generated according to a probability density function of first brightness levels on pixels in the input image. A contrast enhance level is determined according to a flat factor corresponding to the distribution histogram. A weighted histogram corresponding to the input image is calculated according to the distribution histogram and the contrast enhance level. An adjusted histogram corresponding to the input image is generated by decreasing lengths of partial histogram bins in the weighted histogram. A brightness mapping curve is generated according to the adjusted histogram based on histogram equalization. The first brightness levels on the pixel in the input image are mapped into second brightness levels on pixels in an output image according to the brightness mapping curve.

### BACKGROUND

### Field of Invention

The disclosure relates to an image enhancement method and an image processing device. More particularly, the disclosure relates to an image enhancement method capable of enhancing a contrast level of an image.

### Description of Related Art

Techniques based on histogram equalization and histogram modification are the main ideas to enhance the overall brightness and contrast of the image for preserving the image naturalness. On one hand, these methods usually result in excessive contrast enhancement, which in turn give the processed image an unnatural look and create visual artifacts. On the one hand, these techniques cannot adjust the level of enhancement and are not robust to noise. It is a challenging task about how to adaptively adjust the level of contrast enhancement without visual artifact.

### SUMMARY

The disclosure provides an image enhancement method, which include following steps. A distribution histogram corresponding to an input image is generated according to a probability density function of first brightness levels on pixels in the input image. A contrast enhance level is determined according to a flat factor corresponding to the distribution histogram. The contrast enhance level is negatively correlated to the flat factor. A weighted histogram corresponding to the input image is calculated according to the distribution histogram and the contrast enhance level. An adjusted histogram corresponding to the input image is generated by decreasing lengths of partial histogram bins in the weighted histogram. A brightness mapping curve is generated according to the adjusted histogram based on histogram equalization. The first brightness levels on the pixel in the input image are mapped into second brightness levels on pixels in an output image according to the brightness mapping curve.

The disclosure also provides an image processing device, which includes an image receiving unit, a processing unit and a storage unit. The image receiving unit is configured for receiving an input image comprising a plurality of pixels. The storage unit is configured for storing a program code. The program code is configured for instructing the processing unit to execute the following steps. A distribution histogram corresponding to an input image is generated according to a probability density function of first brightness levels on pixels in the input image. A contrast enhance level is determined according to a flat factor corresponding to the distribution histogram. The contrast enhance level is negatively correlated to the flat factor. A weighted histogram corresponding to the input image is calculated according to the distribution histogram and the contrast enhance level. An adjusted histogram corresponding to the input image is generated by decreasing lengths of partial histogram bins in the weighted histogram. A brightness mapping curve is generated according to the adjusted histogram based on histogram equalization. The first brightness levels on the pixel in the input image are mapped into second brightness levels on pixels in an output image according to the brightness mapping curve.

It is to be understood that both the foregoing general description and the following detailed description are demonstrated by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an image processing device according to some embodiments of this disclosure.

FIG. 2 is a flow chart illustrating an image enhancement method according to some embodiments of this disclosure.

FIG. 3A, FIG. 3B and FIG. 3C are schematic diagram illustrating three demonstrational examples of input images and related histograms corresponding to these input images.

FIG. 4 is a flow chart illustrating some detail steps within the adaptive contrast enhancement according to some embodiments of this disclosure.

FIG. 5 is a flow chart illustrating detail steps within the classification process and detail steps within the weighted histogram calculation shown in FIG. 4 according to some embodiments of this disclosure.

FIG. 6 is a mapping curve between the flat factor and the contrast enhance level (k) according to some embodiments.

FIG. 7A, FIG. 7B and FIG. 7C are schematic diagram illustrating three demonstrational examples of distribution histograms corresponding to the input images and related detail histogram and weighted histograms according to some embodiments.

FIG. 8 is a flow chart illustrating detail steps within the adaptive adjustment shown in FIG. 4 according to some embodiments of this disclosure.

FIG. 9A is a mapping curve between the dark brightness threshold and the average of the brightness levels on the pixels in the input image according to some embodiments.

FIG. 9B is a mapping curve between the light brightness threshold and the percentile 90 of the brightness levels on the pixels in the input image according to some embodiments.

FIG. 10 illustrated an example about an adjusted histogram generated from the weighted histogram.

FIG. 11A to FIG. 11C illustrate examples about brightness mapping curves corresponding to the input images according to some embodiments.

FIG. 12A to FIG. 12C illustrate examples about the output images according to some embodiments.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

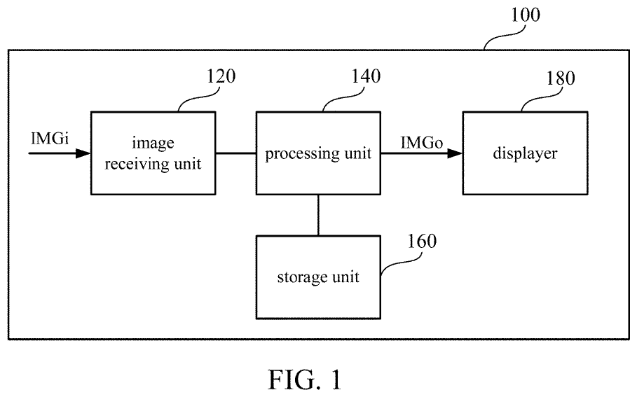

Reference is made to FIG. 1, which is a schematic diagram illustrating an image processing device 100 according to some embodiments of this disclosure. In some embodiments as shown in FIG. 1, the image processing device 100 includes an image receiving unit 120, a processing unit 140 and a storage unit 160. In some embodiments, the image processing device 100 can be a computer, a smartphone, a tablet, a smart television, a set-up box, an image processing server, a data server or any equivalent image processing device.

The image receiving unit 120 is configured to receive an input image IMGi, and the image processing device 100 can enhance parameters of the input image IMGi (e.g., contrast enhancement). The image processing device 100 is able to display the enhanced result (i.e., an output image IMGo) on a displayer 180 of the image processing device 100 or provide the enhanced result to an external device (not shown in figures). The image receiving unit 120 can be a data interface or a wireless communication circuit.

The processing unit 140 is coupled with the image receiving unit 120 and the storage unit 160. The storage unit 160 is configured to store a program code. The program code stored in the storage unit 160 is configured for instructing the processing unit 140 to execute an image enhancement method on the input image IMGi for generating the output image IMGo. In some embodiments, the processing unit 140 can be a processor, a graphic processor, an application specific integrated circuit (ASIC) or any equivalent processing circuit.

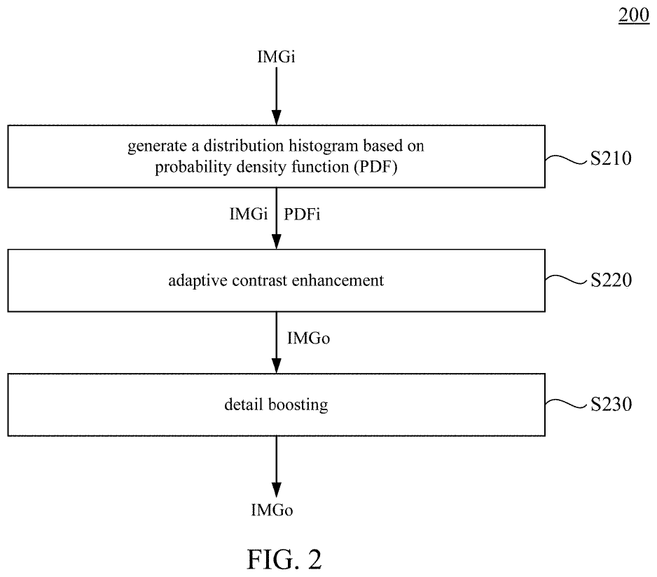

Reference is further made to FIG. 2, which is a flow chart illustrating an image enhancement method 200 according to some embodiments of this disclosure. The image enhancement method 200 as shown in FIG. 2 can be executed by the processing unit 140 in FIG. 1 to enhance the input image IMGi.

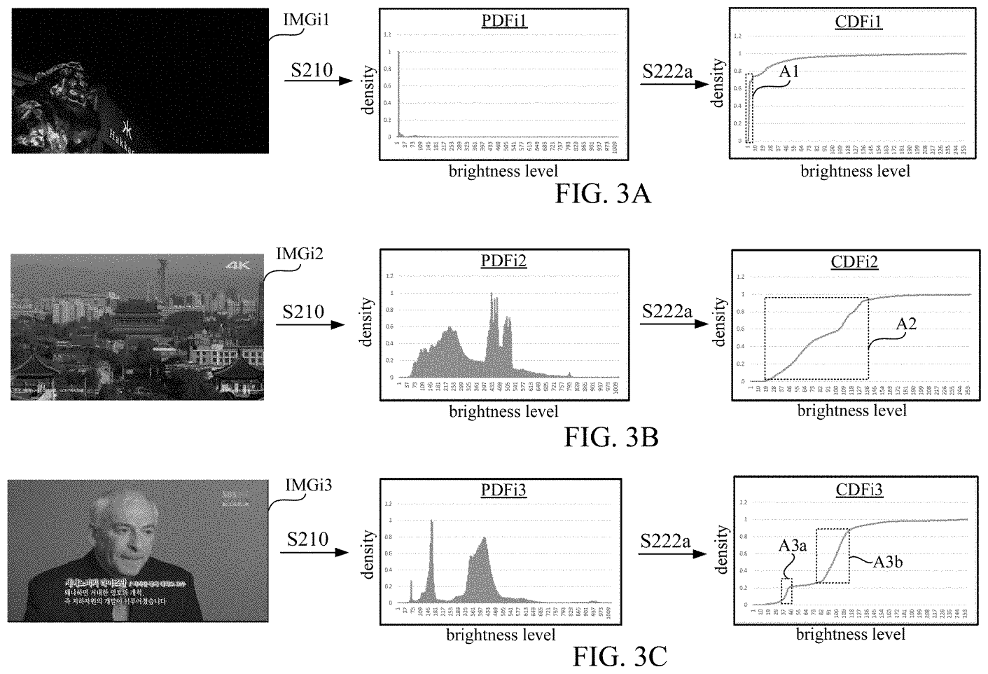

As shown in FIG. 1 and FIG. 2, step S210 is executed, by the processing unit 140, to generate a distribution histogram corresponding to the input image IMGi according to a probability density function of brightness levels on the pixels in the input image IMGi. Reference is further made to FIG. 3A, FIG. 3B and FIG. 3C, which are schematic diagram illustrating three demonstrational examples of input images IMGi1, IMGi2 and IMGi3 and related histograms corresponding to these input images IMGi1, IMGi2 and IMGi3.

As shown in FIG. 3A, the input images IMGi1 shows a scenic photo with a building during a night time, and a major portion of the input images IMGi1 shows the sky in the dark. In this case, this major portion of the pixels (about the dark sky) in the input image IMGi1 has relatively lower brightness levels, and a small portion of some other pixels (about the building) has relative higher brightness levels. In step S210, the processing unit 140 generates a distribution histogram PDFi1 corresponding to the input image IMGi1 according to the probability density function of brightness levels on the pixels in the input image IMGi1. As shown in FIG. 3A, the distribution histogram PDFi1 is highly concentrated at the lower brightness levels (between 1^{st} and 37^{th} brightness levels). In these cases shown in FIG. 3A to FIG. 3C, the brightness levels of the pixels in the input image IMGi1 are in a range between 1^{st} and 1024^{th} for demonstration, but the disclosure is not limited thereto. The lower brightness levels are darker and the higher brightness levels are brighter.

As shown in FIG. 3B, the input images IMGi2 shows a city view with buildings, trees and other various objects during a day time. In this case, the pixels in the input image IMGi2 are evenly distributed over different brightness levels from high to low. In step S210, the processing unit 140 generates a distribution histogram PDFi2 corresponding to the input image IMGi2 according to the probability density function of brightness levels on the pixels in the input image IMGi2. As shown in FIG. 3B, the distribution histogram PDFi2 is distributed over a wider range between 73^{rd} and 793^{rd}, and has some peaks around 433^{rd} and 505^{th}, and a plateau between 73^{rd} and 289^{th}.

As shown in FIG. 3C, the input images IMGi3 shows a person indoor in front of a plane background. In this case, the pixels in the input image IMGi2 include different areas about the plane background, the black suit and the face of the person. In step S210, the processing unit 140 generates a distribution histogram PDFi3 corresponding to the input image IMGi3 according to the probability density function of brightness levels on the pixels in the input image IMGi3. As shown in FIG. 3C, the distribution histogram PDFi3 has some peaks around 145^{th} and 433^{rd}.

As shown in FIG. 1 and FIG. 2, based on the distribution histogram PDFi generated in step S210, step S220 is executed by the processing unit 140 to perform an adaptive contrast enhancement on the input image IMGi, so as to generate an output image IMGo. In some embodiments, the adaptive contrast enhancement is able to classify the input image IMGi (e.g., IMGi1-IMGi3 shown in FIG. 3A to FIG. 3C) according to the information of the corresponding distribution histogram PDFi (e.g., PDFi1-PDFi3 shown in FIG. 3A to FIG. 3C), and different types of the input images will be enhanced with different configurations. In other words, the input images IMGi1-IMGi3 shown in FIG. 3A to FIG. 3C will be enhanced with different configurations adaptively.

In some embodiments, the adaptive contrast enhancement in step S220 classifies the input images IMGi for different exposures and different types of image and determines a corresponding contrast enhance level, which prevents the input images IMGi from being over-enhanced. The adaptive contrast enhancement in step S220 is able to make the appropriate enhancement without artifacts such as noise and contour boosting. It is noticed that more details about the adaptive contrast enhancement in step S220 will be further discussed and explained in following paragraphs.

Afterward, in some embodiments, the image enhancement method 200 in FIG. 2 may further perform a detail boosting process in step S230, by the processing unit 140, to enhance contour details in the output image IMGo after the adaptive contrast enhancement. In some embodiments, the detail boosting process in step S230 can be achieved by an un-sharp masking (USM) method.

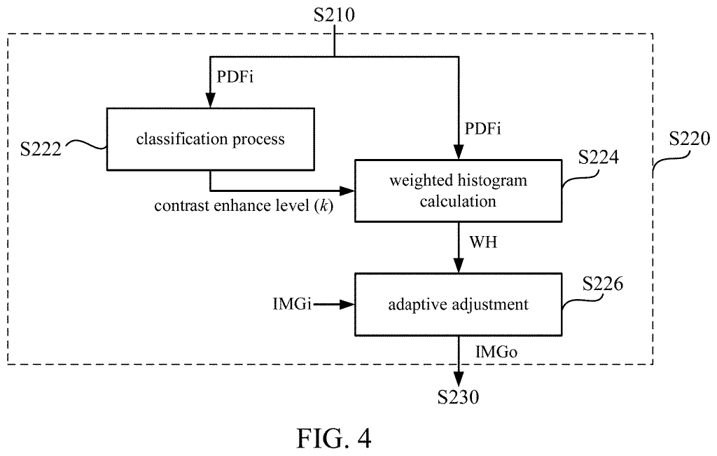

Reference is further made to FIG. 4, which is a flow chart illustrating some detail steps S222-S226 within the adaptive contrast enhancement in step S220 shown in FIG. 2 according to some embodiments of this disclosure.

As shown in FIG. 4, the adaptive contrast enhancement (step S220) includes three steps S222-S226. In step S222, the processing unit 140 performs a classification process on distribution histogram PDFi corresponding to the input image IMGi, and determine a contrast enhance level (k) suitable for the input image IMGi. For different types (e.g., a large dark background, a larger bright background, various objects with different brightness or no specific target) of the input images IMGi, the contrast enhance level (k) can be different. In some embodiments, the processing unit 140 determines the contrast enhance level (k) according to a flat factor corresponding to the distribution histogram PDFi of the input image IMGi. The contrast enhance level (k) is negatively correlated to the flat factor.

In step S224, the processing unit 140 calculates a weighted histogram WH corresponding to the input image IMGi according to the distribution histogram PDFi and the contrast enhance level (k). The weighted histogram WH will reflect characteristics of the input image IMGi and the contrast enhance level (k). Based on the weighted histogram WH, in step S226, the processing unit 140 can perform an adaptive adjustment to the input image IMGi and accordingly generates the output image IMGo.

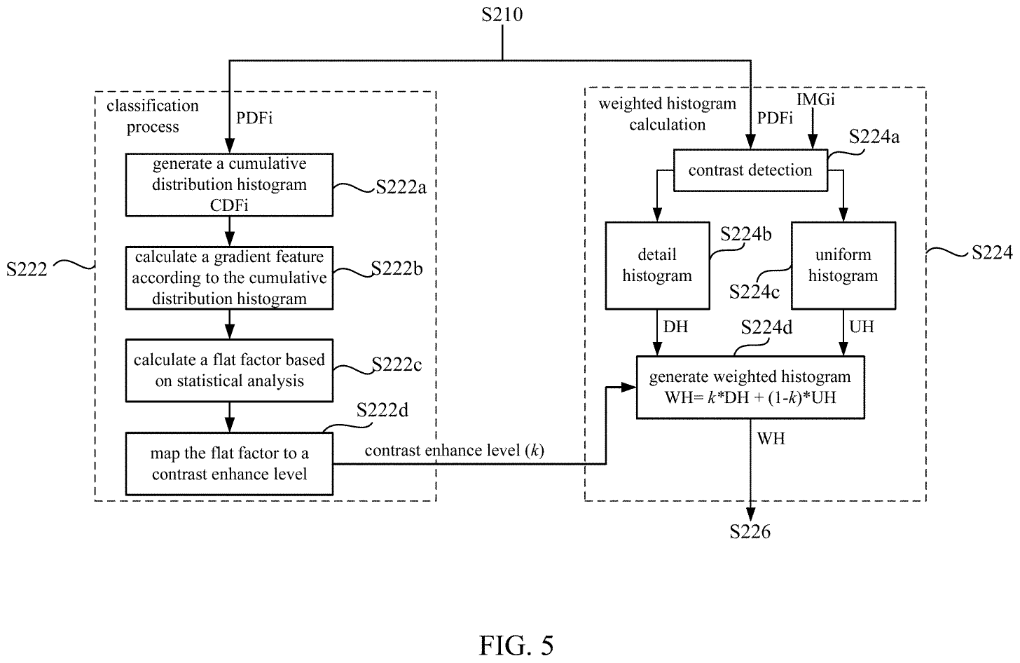

Reference is further made to FIG. 5, which is a flow chart illustrating detail steps S222a-S222d within the classification process (step S222) and detail steps S224a-S224d within the weighted histogram calculation (step S224) shown in FIG. 4 according to some embodiments of this disclosure.

As shown in FIG. 5, in the classification process (S222), the processing unit 140 performs the step S222a to generate a cumulative distribution histogram CDFi according to the distribution histogram PDFi. The cumulative distribution histogram CDFi is a cumulative histogram counts the cumulative densities over the range of all brightness levels (from low brightness to high brightness). The cumulative distribution histogram CDFi show the progression of accusations of the distribution histogram PDFi. The processing unit 140 performs the step S222b to calculate a gradient feature on the cumulative distribution histogram CDFi. The processing unit 140 performs the step S222c to calculate the flat factor according to the gradient feature based on a statistical analysis on the cumulative distribution histogram CDFi.

For example, as shown in FIG. 3A, the cumulative distribution histogram CDFi1 is generated by the processing unit 140 according to the distribution histogram PDFi1 of the input image IMGi1. The gradient feature in the cumulative distribution histogram CDFi1 includes that the distribution histogram CDFi1 rises sharply in an area A1. The gradient feature indicates that the input image IMGi1 includes a large flat area (e.g., the dark sky) with similar brightness level. Based on the statistical analysis on the gradient feature in the cumulative distribution histogram CDFi1, the flat factor corresponding to the distribution histogram PDFi1 of the input image IMGi1 will be determined to be relatively higher.

As shown in FIG. 3B, the cumulative distribution histogram CDFi2 is generated by the processing unit 140 according to the distribution histogram PDFi2 of the input image IMGi2. The gradient feature in the cumulative distribution histogram CDFi2 includes that the cumulative distribution histogram CDFi2 rises smoothly and continuously over another area A2. The gradient feature indicates that the input image IMGi2 does not includes any flat area with similar brightness level, and there are many objects with different brightness levels in the input image IMGi2. Based on the statistical analysis on the gradient feature in the cumulative distribution histogram CDFi2, the flat factor corresponding to the distribution histogram PDFi2 of the input image IMGi2 will be determined to be relatively lower.

As shown in FIG. 3C, the cumulative distribution histogram CDFi3 is generated by the processing unit 140 according to the distribution histogram PDFi3 of the input image IMGi3. The gradient feature in the cumulative distribution histogram CDFi3 includes that the cumulative distribution histogram CDFi3 rises in one area A3a and raises again in another area A3b. The gradient feature indicates that the input image IMGi1 includes one flat area (e.g., the dark suit) with a similar brightness level, and another flat area (e.g., the background) with another similar brightness level. Based on the statistical analysis on the gradient feature in the cumulative distribution histogram CDFi3, the flat factor corresponding to the distribution histogram PDFi3 of the input image IMGi3 will be determined to be relatively higher.

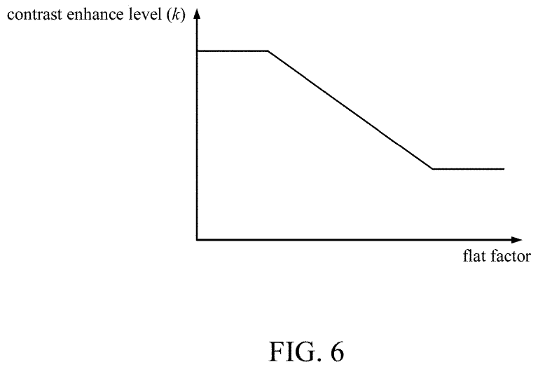

The processing unit 140 performs step S222d to map the flat factor to the contrast enhance level (k). Reference is further made to FIG. 6, which is a mapping curve between the flat factor and the contrast enhance level (k) utilized by the processing unit 140 in the step S222d according to some embodiments. As shown in FIG. 6, when the flat factor is higher, the contrast enhance level (k) is determined to be lower. As shown in FIG. 6, when the flat factor is higher, the contrast enhance level (k) is determined to be lower. The contrast enhance level (k) decides an enhancement degree in following adaptive adjustment. If the contrast enhance level (k) is higher, the image enhancement method 200 will enhance the contrast of the input image IMGi more aggressively, so as to make dark pixels becomes darker and bright pixel become brighter. As shown in FIG. 4, classification process classifies the images according to the probability density.

In some embodiments, when the input image (such as IMGi2 in FIG. 3B) has a smaller gradient, the flat factor is calculated to be lower and the contrast enhance level is determined to be higher. In some embodiments, when the input image (such as IMGi1 in FIG. 3A or IMGi3 in FIG. 3C) has a bigger gradient, the flat factor is calculated to be higher and the contrast enhance level is determined to be lower.

As shown in FIG. 5, in the weighted histogram calculation (S224), the processing unit 140 performs the step S224a to perform a contrast detection between pixels in the input image IMGi. The contrast detection is performed to measure contrast degrees of the pixels in the input image IMGi along a vertical direction and a horizontal direction. Based on the contrast detection, a detail histogram DH is generated in step S224b by the measured contrast degrees of the pixels in the input image IMGi. When a brightness level of a target pixel is different from surrounding pixels, the target pixel is accumulated in the detail histogram DH. The detail histogram DH is step S224b is generated according to a differential portion of the distribution histogram PDFi. The detail histogram DH shows detail graphic features (besides the background or a flat plane area), such as facial area of a person. The uniform histogram UH is step S224c is generated according to a common portion of the distribution histogram PDFi. When the input image IMGi includes a lot of pixels with the similar brightness levels (e.g., a large background), the uniform histogram UH will has a higher bin length. If the input image IMGi includes a lot of detail features with the various different brightness levels (e.g., no obvious background and a lot of objects, such as IMGi2 in FIG. 3B), the uniform histogram UH will has a lower bin length.

As shown in FIG. 5, the processing unit 140 performs the step S224d to calculating the weighted histogram WH corresponding to the input image IMGi according to the detail histogram DH, the uniform histogram UH and the contrast enhance level (k). In some embodiments, the weighted histogram WH is calculated by:

WH[1,1024]=k*DH[1,1024]+(1−k)*UH[1,1024] (1)

In aforesaid equation (1), WH[1,1024] means the histogram bin lengths from 1^{st} brightness level to 1024^{th} brightness level in the weighted histogram WH; DH[1,1024] means the histogram bin lengths from 1^{st} brightness level to 1024^{th} brightness level in the detail histogram DH; k means the contrast enhance level; and UH[1, 1024] means the histogram bin lengths from 1^{st} brightness level to 1024^{th} brightness level in the uniform histogram UH.

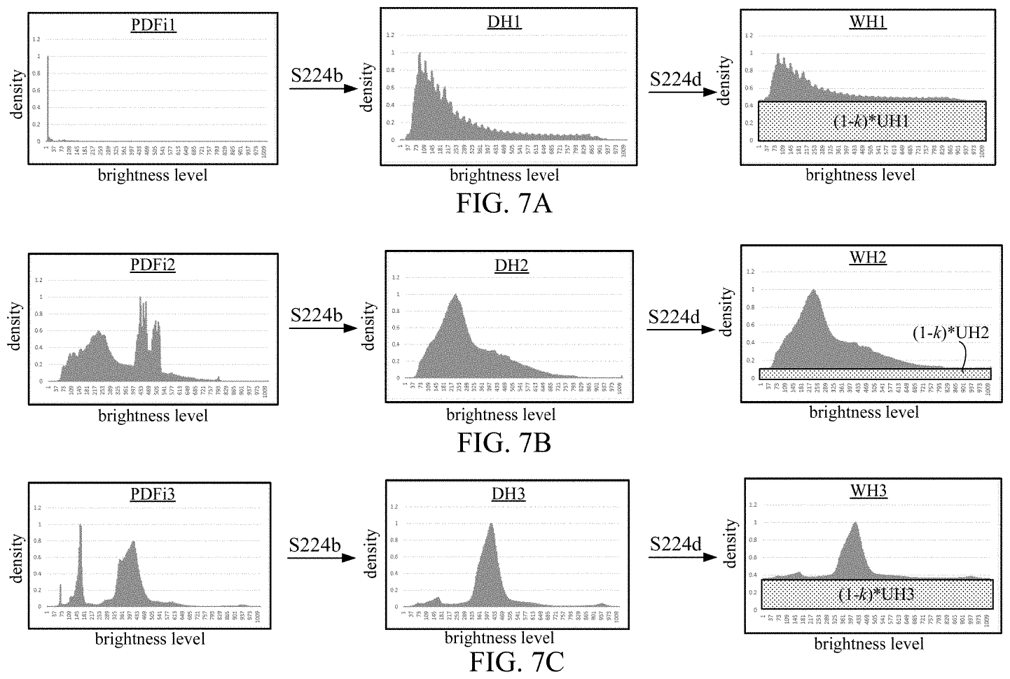

Reference is further made to FIG. 7A, FIG. 7B and FIG. 7C, which are schematic diagram illustrating three demonstrational examples of distribution histograms PDFi1-PDFi3 corresponding to the input images IMGi1, IMGi2 and IMGi3 in FIG. 3A to FIG. 3C and related detail histograms DH1-DH3 and weighted histograms WH1-WH3 according to some embodiments.

As shown in FIG. 7A, the processing unit 140 generates the detail histogram DH1 according to the distribution histograms PDFi1, and then the processing unit 140 generates the weighted histogram WH1 by:

WH1=k*DH1+(1−k)*UH1

As shown in FIG. 3A and FIG. 7A, because the input images IMGi1 has a large area of dark sky, the uniform histogram UH1 is relatively higher.

As shown in FIG. 7B, the processing unit 140 generates the detail histogram DH2 according to the distribution histograms PDFi2, and then the processing unit 140 generates the weighted histogram WH2 by:

WH2=k*DH2+(1−k)*UH2

As shown in FIG. 3B and FIG. 7B, because the input images IMGi2 does not has any large flat plane, the uniform histogram UH2 is relatively lower.

As shown in FIG. 7C, the processing unit 140 generates the detail histogram DH3 according to the distribution histograms PDFi3, and then the processing unit 140 generates the weighted histogram WH3 by:

WH3=k*DH3+(1−k)*UH3

As shown in FIG. 3C and FIG. 7C, because the input images IMGi3 has two flat planes (suit and background), the uniform histogram UH3 is relatively higher than the uniform histogram UH2.

After the weighted histogram WH corresponding to the input image IMGi is generated in S224, step S226 is performed by the processing unit 140 to perform an adaptive adjustment on the input image IMGi based on the weighted histogram WH, so as to generate to the input image IMGo.

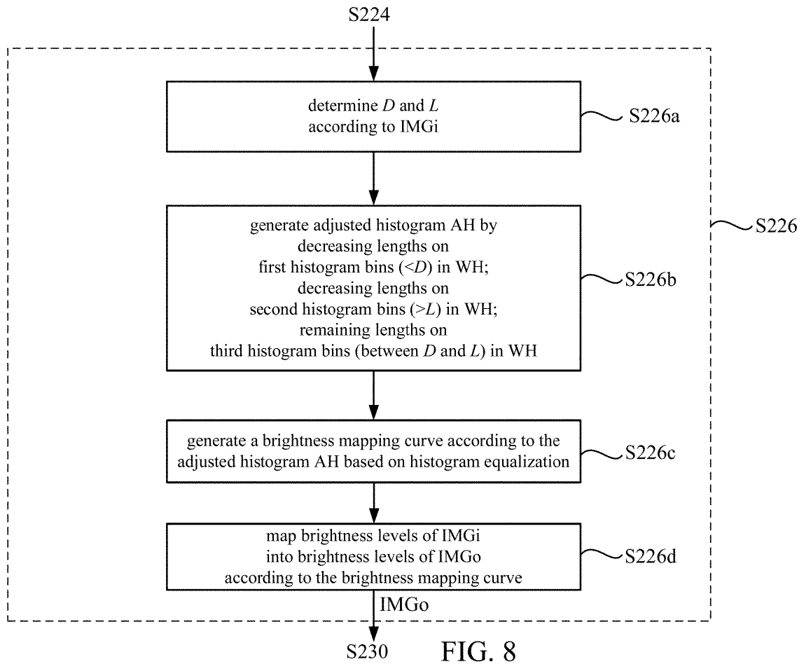

Reference is further made to FIG. 8, which is a flow chart illustrating detail steps S226a-S226d within the adaptive adjustment (step S226) shown in FIG. 4 according to some embodiments of this disclosure. As shown in FIG. 1 and FIG. 8, the processing unit 140 determines a dark brightness threshold D and a light brightness threshold L according to statistic features of the brightness levels on the pixels in the input image IMGi in step S226a. The dark brightness threshold D is lower than the light brightness threshold L.

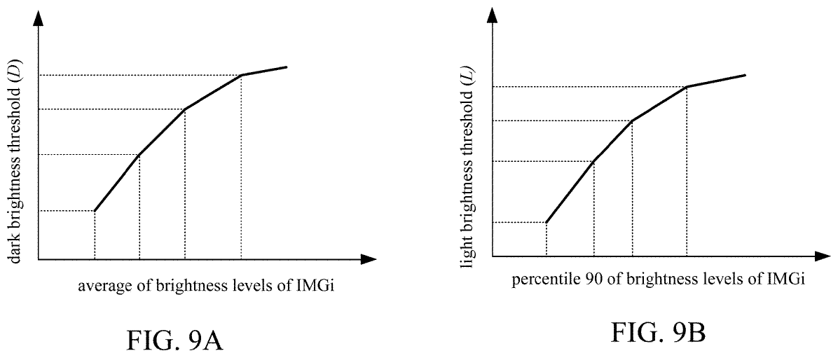

In some embodiments, wherein the dark brightness threshold D is determined according to an average of the brightness levels on the pixels in the input image IMGi. Reference is further made to FIG. 9A, which is a mapping curve between the dark brightness threshold D and the average of the brightness levels on the pixels in the input image IMGi utilized by the processing unit 140 in the step S226a according to some embodiments.

In some embodiments, wherein the light brightness threshold L is determined according to a percentile 90 of the brightness levels on the pixels in the input image IMGi. Reference is further made to FIG. 9B, which is a mapping curve between the light brightness threshold L and the percentile 90 of the brightness levels on the pixels in the input image IMGi utilized by the processing unit 140 in the step S226a according to some embodiments.

It is noticed that, relative to different input images IMGi, the dark brightness threshold D and the light brightness threshold L will be determined to be different values. For example, relative to the input image IMGi1, the dark brightness threshold D can 40 and the light brightness threshold L can be 800. Relative to the input image IMGi2, the dark brightness threshold D can 139 and the light brightness threshold L can be 770. Relative to the input image IMGi3, the dark brightness threshold D can 62 and the light brightness threshold L can be 988.

As shown in FIG. 1 and FIG. 8, the processing unit 140 generates an adjusted histogram AH corresponding to the input image IMGi by decreasing lengths of partial histogram bins in the weighted histogram WH in step S226a.

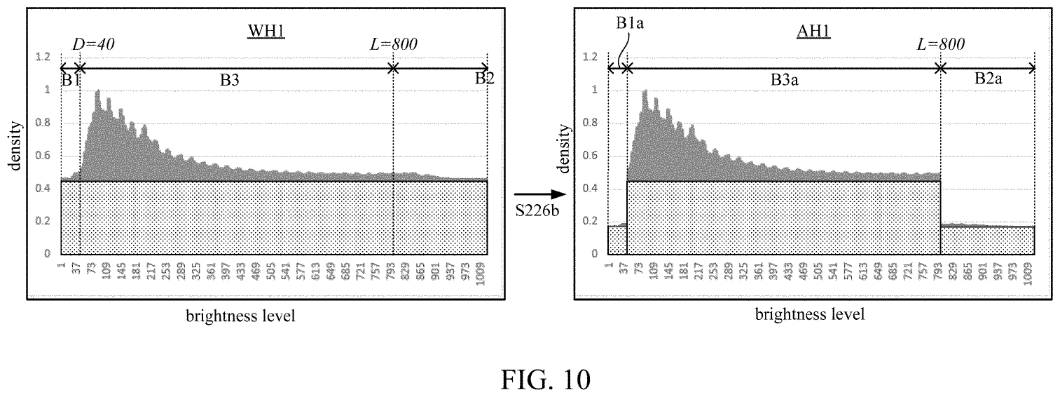

Reference is further made to FIG. 10, which illustrated an example about an adjusted histogram AH1 generated from the weighted histogram WH1 in step S226a. In some embodiments, as shown in FIG. 10, in step S226a, the processing unit 140 decreases lengths on first histogram bins B1 lower than the dark brightness threshold D in the weighted histogram WH1 as a first part B1a of the adjusted histogram AH1; the processing unit 140 also decreases lengths on first histogram bins B2 higher than the light brightness threshold L in the weighted histogram WH1 as a second part B2a of the adjusted histogram AH1; lengths on third histogram bins B3 between the dark brightness threshold D and the light brightness threshold L in the weighted histogram WH1 are remained the same as a third part B3a of the adjusted histogram AH1.

It is noticed that FIG. 10 is an example about how to generate the adjusted histogram AH1 from the weighted histogram WH1. Similarly, another adjusted histogram (not shown in figures) can be generated from the weighted histogram WH2 shown in FIG. 7B. Similarly, still another adjusted histogram (not shown in figures) can be generated from the weighted histogram WH3 shown in FIG. 7C.

As shown in FIG. 1 and FIG. 8, in step S226c, the processing unit 140 generates a brightness mapping curve according to the adjusted histogram AH based on histogram equalization. Histogram equalization is a method in image processing of contrast adjustment using the image's histogram (e.g., the adjusted histogram AH in this disclosure). Histogram equalization usually increases the global contrast of many images, especially when the usable data of the image is represented by close contrast values. Through this adjustment, the intensities can be better distributed on the histogram. Histogram equalization accomplishes this by effectively spreading out the most frequent intensity values. As shown in FIG. 10, because the adjusted histogram AH1 has shorter bin lengths in B1a and shorter bin lengths in B2a, the brightness mapping curve generated according to the adjusted histogram AH1 will make the make dark pixels darker, while makes bright pixels brighter.

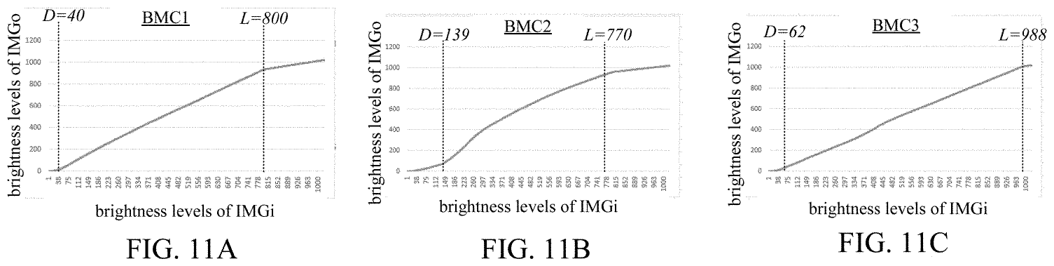

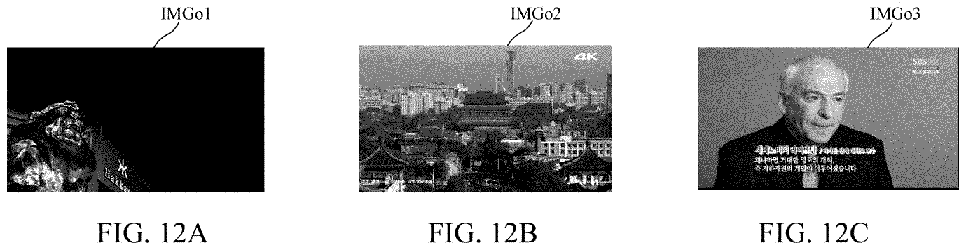

Reference is further made to FIG. 11A to FIG. 11C and FIG. 12A to FIG. 12C. FIG. 11A to FIG. 11C illustrate examples about brightness mapping curves BMC1-BMC3 corresponding to the input images IMGi1 to IMGi3 in FIG. 3A to FIG. 3C according to some embodiments. FIG. 12A to FIG. 12C illustrate examples about the output images IMGo1 to IMGo3 according to some embodiments.

As shown in FIG. 11A, the brightness mapping curves BMC1 is able to map the pixels in the input image IMGi1 with brightness level lower than the dark brightness threshold D (D=40) to be darker in the output image IMGo1, such that these pixels will have lower brightness levels in the output image IMGo1. The brightness mapping curves BMC1 is able to map the pixels in the input image IMGi1 with brightness level higher than the light brightness threshold L (L=800) to be brighter in the output image IMGo1, such that these pixels will have higher brightness levels in the output image IMGo1. In this case, the contrast level of the output image IMGo1 can be enhanced as shown in FIG. 12A.

As shown in FIG. 11B, the brightness mapping curves BMC2 is able to map the pixels in the input image IMGi2 with brightness level lower than the dark brightness threshold D (D=139) to be darker in the output image IMGo2, such that these pixels will have lower brightness levels in the output image IMGo2. The brightness mapping curves BMC2 is able to map the pixels in the input image IMGi2 with brightness level higher than the light brightness threshold L (L=770) to be brighter in the output image IMGo2, such that these pixels will have higher brightness levels in the output image IMGo2. In this case, the contrast level of the output image IMGo2 can be enhanced as shown in FIG. 12B.

As shown in FIG. 11C, the brightness mapping curves BMC3 is able to map the pixels in the input image IMGi3 with brightness level lower than the dark brightness threshold D (D=62) to be darker in the output image IMGo3, such that these pixels will have lower brightness levels in the output image IMGo3. The brightness mapping curves BMC3 is able to map the pixels in the input image IMGi3 with brightness level higher than the light brightness threshold L (L=988) to be brighter in the output image IMGo3, such that these pixels will have higher brightness levels in the output image IMGo3. In this case, the contrast level of the output image IMGo3 can be enhanced as shown in FIG. 12C.

Based on aforesaid embodiments, the image enhancement method 200 considers the image under different exposure conditions and performs the better adaptive enhancement. Firstly, the image enhancement method 200 classifies the images for different exposure and different types of image gets different contrast enhance level, which prevents some images from being over-enhanced. Secondly, the image enhancement method 200 makes the appropriate enhancement without artifacts such as noise and contour boosting.

Based on aforesaid embodiments, the proposed image enhancement method 200 performs the adaptive contrast enhancement based on pre-classification method of framework consists of three parts including the classification process, the weighted histogram calculation and the adaptive adjustment. In some embodiments, adaptive adjustment is configured to adjust histogram bin lengths for the corresponding gray-level ranges adaptively according to the luminance and percentile of the input image.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An image enhancement method, comprising:
generating a distribution histogram corresponding to an input image according to a probability density function of first brightness levels on pixels in the input image;
determining a contrast enhance level according to a flat factor corresponding to the distribution histogram, wherein the contrast enhance level is negatively correlated to the flat factor;
calculating a weighted histogram corresponding to the input image according to the distribution histogram and the contrast enhance level;
generating an adjusted histogram corresponding to the input image by decreasing lengths of partial histogram bins in the weighted histogram;
generating a brightness mapping curve according to the adjusted histogram based on histogram equalization; and
mapping the first brightness levels on the pixel in the input image into second brightness levels on pixels in an output image according to the brightness mapping curve.

2. The image enhancement method according to claim 1, wherein the flat factor corresponding to the distribution histogram is calculated by:
generating a cumulative distribution histogram according to the distribution histogram;
calculating a gradient feature on the cumulative distribution histogram; and
calculating the flat factor according to the gradient feature.

3. The image enhancement method according to claim 2, wherein:
in response to that the cumulative distribution histogram corresponding to the input image has a smaller gradient, the flat factor is calculated to be lower and the contrast enhance level is determined to be higher, and
in response to that the cumulative distribution histogram corresponding to the input image has a bigger gradient, the flat factor is calculated to be higher and the contrast enhance level is determined to be lower.

4. The image enhancement method according to claim 2, wherein the flat factor indicates whether the input image comprising a large area with similar colors.

5. The image enhancement method according to claim 1, wherein step of calculating the weighted histogram comprises:
generating a detail histogram from the input image;
calculating a first product of the contrast enhance level and the detail histogram;
generating a uniform histogram from the input image;
calculating a second product of a complement of the contrast enhance level and the uniform histogram; and
summing the first product and the second product as the weighted histogram.

6. The image enhancement method according to claim 5, wherein the detail histogram is generated by measuring contrast degrees of the pixels in the input image along a vertical direction and a horizontal direction.

7. The image enhancement method according to claim 5, wherein the uniform histogram is generated by measuring a common degree of the pixels in the input image.

8. The image enhancement method according to claim 1, wherein step of generating the adjusted histogram comprises:
determining a dark brightness threshold and a light brightness threshold according to statistic features of the first brightness levels on the pixels in the input image, wherein the dark brightness threshold is lower than the light brightness threshold;
decreasing lengths on first histogram bins lower than the dark brightness threshold in the weighted histogram as a first part of the adjusted histogram;
decreasing lengths on second histogram bins higher than the light brightness threshold in the weighted histogram as a second part of the adjusted histogram; and
remaining lengths on third histogram bins between the dark brightness threshold and the light brightness threshold in the weighted histogram as a third part of the adjusted histogram.

9. The image enhancement method according to claim 8, wherein the dark brightness threshold is determined according to an average of the first brightness levels on the pixels in the input image.

10. The image enhancement method according to claim 8, wherein the light brightness threshold is determined according to a percentile 90 of the first brightness levels on the pixels in the input image.

11. An image processing device, comprising:
an image receiving unit, for receiving an input image comprising a plurality of pixels;
a processing unit; and
a storage unit, for storing a program code, the program code for instructing the processing unit to execute the following steps:
generating a distribution histogram corresponding to the input image according to a probability density function of first brightness levels on the pixels in the input image;
determining a contrast enhance level according to a flat factor corresponding to the distribution histogram, wherein the contrast enhance level is negatively correlated to the flat factor;
calculating a weighted histogram corresponding to the input image according to the distribution histogram and the contrast enhance level;
generating an adjusted histogram corresponding to the input image by decreasing lengths of partial histogram bins in the weighted histogram;
generating a brightness mapping curve according to the adjusted histogram based on histogram equalization; and
mapping the first brightness levels on the pixel in the input image into second brightness levels on pixels in an output image according to the brightness mapping curve.

12. The image processing device according to claim 11, further comprising:
a displayer coupled with the processing unit, wherein the displayer is configured to display the output image.

13. The image processing device according to claim 11, wherein the processing unit calculates the flat factor by:
generating a cumulative distribution histogram according to the distribution histogram;
calculating a gradient feature on the cumulative distribution histogram; and
calculating the flat factor according to the gradient feature.

14. The image processing device according to claim 13, wherein,
in response to that the cumulative distribution histogram corresponding to the input image has a smaller gradient, the flat factor is calculated to be lower and the contrast enhance level is determined to be higher, and
in response to that the cumulative distribution histogram corresponding to the input image has a bigger gradient, the flat factor is calculated to be higher and the contrast enhance level is determined to be lower.

15. The image processing device according to claim 13, wherein the flat factor indicates whether the input image comprising a large area with similar colors.

16. The image processing device according to claim 11, wherein the processing unit calculates the weighted histogram by:
generating a detail histogram from the input image;
calculating a first product of the contrast enhance level and the detail histogram;
generating a uniform histogram from the input image;
calculating a second product of a complement of the contrast enhance level and the uniform histogram; and
summing the first product and the second product as the weighted histogram.

17. The image processing device according to claim 16, wherein the detail histogram is generated by measuring contrast degrees of the pixels in the input image along a vertical direction and a horizontal direction.

18. The image processing device according to claim 16, wherein the uniform histogram is generated by measuring a common degree of the pixels in the input image.

19. The image processing device according to claim 11, wherein the processing unit generates the adjusted histogram by:
determining a dark brightness threshold and a light brightness threshold according to statistic features of the first brightness levels on the pixels in the input image, wherein the dark brightness threshold is lower than the light brightness threshold;
decreasing lengths on first histogram bins lower than the dark brightness threshold in the weighted histogram as a first part of the adjusted histogram;
decreasing lengths on second histogram bins higher than the light brightness threshold in the weighted histogram as a second part of the adjusted histogram; and
remaining lengths on third histogram bins between the dark brightness threshold and the light brightness threshold in the weighted histogram as a third part of the adjusted histogram.

20. The image processing device according to claim 19, wherein the dark brightness threshold is determined according to an average of the first brightness levels on the pixels in the input image, and the light brightness threshold is determined according to a percentile 90 of the first brightness levels on the pixels in the input image.
